(19) United States
(12) Patent Application Publication
(10) Pub. No.: US 2026/0009497 A1
(43) Pub. Date: Jan. 8, 2026

(54) BRACKET WITH ADJUSTABLE CENTER OF GRAVITY

(71) Applicant: SHENZHEN MO SEN MO INDUSTRIAL CO., LTD, SHENZHEN (CN)

(72) Inventors: SHENGHU AN, SHENZHEN (CN); QI LU, SHENZHEN (CN)

(21) Appl. No.: 19/328,579

(22) Filed: Sep. 15, 2025

(30) Foreign Application Priority Data
Apr. 9, 2025 (CN) 202520662986.2

(51) Int. Cl. F16M 11/22

(52) U.S. Cl. CPC F16M 11/22; F16M 2200/08

(57) ABSTRACT

The present invention discloses a support with an adjustable center of gravity, comprising a support body and a support arranged on the support body approximately perpendicular to the support plane of the support body, and at least one adjustment plate or adjustment column is actively arranged on the support body, and one end of the support arranged on the support body approximately perpendicular to the support plane of the support body is actively connected to the support body, and the other end of the adjustment plate or adjustment column extends out of the support body on the support plane, thereby causing the center of gravity of the support surface of the support body to move. The present invention has the advantages of easy portability and adjustable center of gravity.

### FIELD

This patent application relates to the field of product brackets, specifically to a bracket that is convenient to carry and has an adjustable center of gravity.

### BACKGROUND

With the increasing popularity of smart electronic products such as smartphones and tablets, these products are typically carried in a handheld manner and used by holding the device body. However, when used for an extended period, such as during long train or plane trips, the fatigue caused by holding the device for an extended time can reduce comfort levels. Additionally, when taking selfies or using the device in certain scenarios, an electronic product bracket is often required to support the smart electronic product, ensuring that the screen or camera is at a reasonable angle for user viewing or use.

When placing relatively heavy electronic products, lamps, or requiring a large bending space for the support rod of the product being placed, the bottom support surface of the bracket needs to be large enough. To ensure stability, a support plate is commonly used at the bottom. However, a large-area support plate is extremely inconvenient to carry.

### SUMMARY

The objective of this invention is to provide a bracket that is convenient to carry and has an adjustable center of gravity to address the issues mentioned above.

A bracket with an adjustable center of gravity includes a support body and a strut disposed on the support body approximately perpendicular to the support plane of the support body. At least one adjustable plate or adjustable column is movably arranged on the support body. One end of the strut, which is disposed on the support body and is approximately perpendicular to the support plane of the support body, is movably connected to the support body. The other end of the adjustable plate or adjustable column extends out of the support body and onto the support plane, thereby causing the center of gravity of the support surface of the support body to shift.

Preferably, at least two adjustable plates or columns are symmetrically arranged.

The support body can be a support plate or a support frame.

On one side of the support body, a strut approximately perpendicular to the support plane of the support body is disposed. On the other side of the support body, two corners are hinged with two strip-shaped adjustable plates. Rotating the adjustable plates can cause the free ends of the adjustable plates to rotate outward around one corner of the support body.

A buffer piece is fixed to the bottom of the adjustable plate.

The outer edge of the adjustable plate extends upward to form an upper folding edge.

The adjustable plate or adjustable column is slidably disposed on the support body. When the adjustable plate or adjustable column slides outward, the center of gravity of the support surface moves outward.

One end of the adjustable plate or adjustable column is slidably disposed on the support body, and at the same time, one end of the adjustable plate or adjustable column is hinged to the slideway of the support body.

By movably arranging an adjustable plate or adjustable column on the support body, with the free end of the adjustable plate or adjustable column extending out of the support body onto the support plane, the support surface is increased, and the center of gravity of the support surface of the support body is shifted. This enables the adjustment of the position of the strut and/or the placement of heavier objects by rotating the adjustable plate or adjustable column according to the size and position of the object to be placed on the strut.

### BRIEF DESCRIPTION OF THE DRAWINGS

FIG. 1 shows a structural diagram of an embodiment of the bracket with an adjustable center of gravity.

FIG. 2 shows an unfolded diagram of an embodiment of the bracket with an adjustable center of gravity.

FIG. 3 shows an exploded view of an embodiment of the bracket with an adjustable center of gravity.

### DESCRIPTION

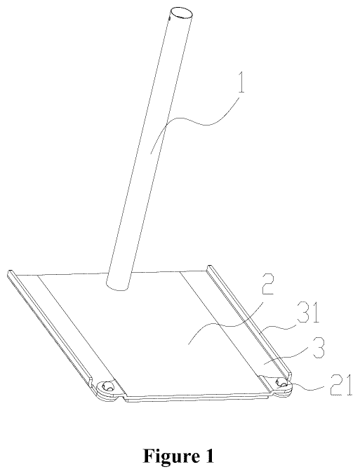

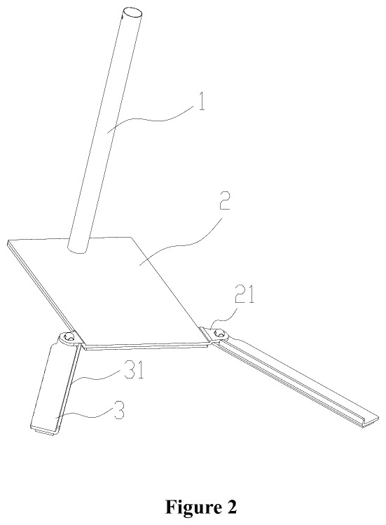

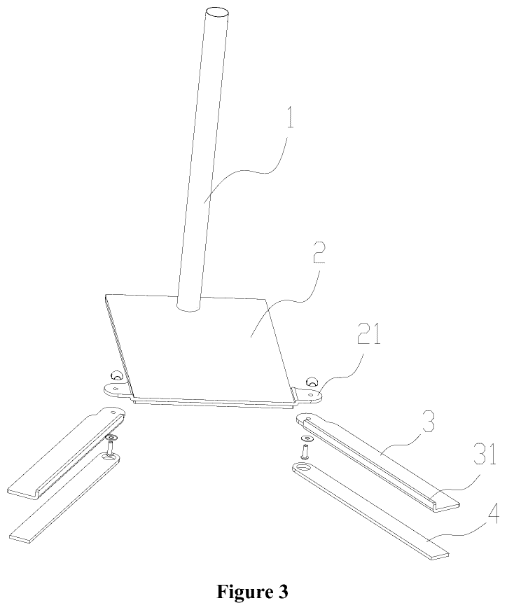

With reference to FIGS. 1-3, an embodiment of the bracket with an adjustable center of gravity is described below.

This bracket includes a supporting base plate 2 and a strut 1 disposed on one side of the supporting base plate 2 approximately perpendicular to the support plane of the supporting base plate 2. On the other side of the supporting base plate 2, two hinge pieces 21 protrude horizontally upward from two corners. A strip-shaped adjustable plate 3 is hinged to the hinge pieces 21 by screws. Rotating the adjustable plate 3 can cause the free end of the adjustable plate 3 to rotate outward around one corner of the supporting base plate 2, thereby changing the center of gravity of the support surface of the supporting base plate 2.

In another aspect, a buffer sponge piece 4 is fixed to the bottom of the adjustable plate 3 to prevent scratching the floor or tabletop during rotation. Also, the outer edge of the adjustable plate 3 extends upward to form an upper folding edge 31, which makes it easier to rotate the adjustable plate 3.

In addition to the above embodiments, in other possible configurations: the adjustable plate or adjustable column can be slidably disposed on the support body. When the adjustable plate or adjustable column slides outward, the center of gravity of the support surface moves outward. Moreover, one end of the adjustable plate or adjustable column is slidably disposed on the support body while being hinged to the slideway of the support body, providing a larger adjustment range.

It should be noted that the above embodiments are provided to help understand the present invention, but the implementation of the present invention is not limited to these embodiments. Any changes, modifications, substitutions, combinations, or simplifications made without departing from the principles of the present invention are considered equivalent replacements and are within the scope of protection of the present invention.

1. A bracket with an adjustable center of gravity, comprising:
a support body;
a strut disposed on the support body approximately perpendicular to the support plane of the support body;
at least one adjustable plate or adjustable column movably arranged on the support body, wherein one end of the strut, which is disposed on the support body and is approximately perpendicular to the support plane of the support body, is movably connected to the support body, and the other end of the adjustable plate or adjustable column extends out of the support body and onto the support plane, thereby causing the center of gravity of the support surface of the support body to shift.

2. The bracket with an adjustable center of gravity according to claim 1, wherein at least two adjustable plates or columns are symmetrically arranged.

3. The bracket with an adjustable center of gravity according to claim 1, wherein the support body is a support plate or a support frame.

4. The bracket with an adjustable center of gravity according to claim 1, wherein a strut approximately perpendicular to the support plane of the support body is disposed on one side of the support body, and two corners on the other side of the support body are hinged with two strip-shaped adjustable plates, and rotating the adjustable plates can cause the free ends of the adjustable plates to rotate outward around one corner of the support body.

5. The bracket with an adjustable center of gravity according to claim 4, wherein a buffer piece is fixed to the bottom of the adjustable plate.

6. The bracket with an adjustable center of gravity according to claim 5, wherein the outer edge of the adjustable plate extends upward to form an upper folding edge.

7. The bracket with an adjustable center of gravity according to claim 1, wherein the adjustable plate or adjustable column is slidably disposed on the support body, and when the adjustable plate or adjustable column slides outward, the center of gravity of the support surface moves outward.

8. The bracket with an adjustable center of gravity according to claim 1, wherein one end of the adjustable plate or adjustable column is slidably disposed on the support body, and at the same time, one end of the adjustable plate or adjustable column is hinged to the slideway of the support body.
